(19) United States
(12) Patent Application Publication
(10) Pub. No.: US 2022/0212826 A1
(43) Pub. Date: Jul. 7, 2022

(54) CONTROL AND/OR IDENTIFICATION METHOD IN AN AUTOMATIC MACHINE FOR THE PRODUCTION OR THE PACKAGING OF CONSUMER PRODUCTS, IN PARTICULAR OF THE TOBACCO INDUSTRY

(71) Applicant: G.D SOCIETA' PER AZIONI, Bologna (IT)

(72) Inventors: Maria Eleonora Cesarini, Bologna (IT); Eura Trivisonno, Bologna (IT); Luca Federici, Bologna (IT)

(21) Appl. No.: 17/611,686

(22) PCT Filed: Jun. 5, 2020
(86) PCT No.: PCT/IB2020/055327

§ 371 Date: Nov. 16, 2021

(30) Foreign Application Priority Data
Jun. 6, 2019 (IT) 102019000008247
Jun. 6, 2019 (IT) 102019000008250

(51) Int. Cl. B65B 57/08; B65B 19/22; B65B 57/16; B65B 65/00; A24D 3/02; A24F 40/70; G05B 19/418; G01J 3/28

(52) U.S. Cl. CPC B65B 57/08; B65B 19/225; B65B 57/16; B65B 65/003; A24D 3/0295; G05B 2219/32203; A24F 40/70; G05B 19/41875; G01J 3/2823; G05B 2219/32193; A24D 3/0275

(57) ABSTRACT

An automatic machine for the production or the packaging of consumer products, in particular of the tobacco industry has at least one processing line provided with a plurality of operating members and feeds at least one material used to manufacture the consumer products. A control and/or identification method includes carrying out, inside a volume containing at least part of the automatic machine, a three-dimensional detection using at least one hyperspectral detection unit for detecting alterations of the electromagnetic field produced by all the objects inside the volume, the hyperspectral detection unit outputs raw data concerning the dimensions, position, shape, physical structure, and/or the chemical composition of all the objects present inside the volume. The raw data is filtered using an artificial intelligence algorithm to isolate and extract information concerning at least one single object inside the volume; and the information is used to carry out a control and/or identification operation.

### CROSS-REFERENCE TO RELATED APPLICATIONS

This Patent Application claims priority from Italian Patent Applications No. 102019000008247 filed on Jun. 6, 2019, and No. 102019000008250 filed on Jun. 6, 2019, the entire disclosure of which is incorporated herein by reference.

### TECHNICAL FIELD

The present invention relates to a control and/or identification method in an automatic machine for the production or the packaging of consumer products.

The present invention finds advantageous application in the tobacco industry, to which the following disclosure will refer without losing its generality.

### PRIOR ART

An automatic machine for the production or the packaging of products in the tobacco industry comprises at least one processing line which is formed by a plurality of operating members and feeds and combines, with one another, at least two different materials that are used to manufacture the consumer products (e.g. cigarettes, packets, cartons, etc.).

Currently an automatic machine for the production or the packaging of products in the tobacco industry has a plurality of detection units, comprising linear position, angular position, temperature, humidity, optical, microwave, X-ray detection units, in order to try to keep under control both the operational members, the materials and the semi-finished or finished products.

However, keeping all the processing aspects under control requires a large number and a wide variety of detection units and consequently involves very high costs (both for the purchase of the detection units, and for the assembly and wiring of the detection units), large dimension problems, and considerable time expenditure for the calibration of the detection units.

Furthermore, known detection units are not always able to effectively verify whether a product complies with the specifications and, hence, is acceptable or whether the consumer product does not comply with the specifications and, hence, needs to be rejected; in particular, known detection units can lose efficacy when they have to investigate internal features of a product that are not directly accessible from the outside.

Patent application US2018100810A1 describes a method for detecting the presence of foreign material within a flow of agricultural products which is illuminated with light and is then scanned to acquire a hyperspectral image; the hyperspectral image is analyzed to obtain measured spectrum data which is then compared with predetermined spectrum data (sample) in order to determine whether the measured spectrum data is indicative of the presence of foreign material.

Patent application US2019137979A1 describes a balancing method of a production line which provides the generation of recommendations to move one or more procedures from one station to another station in order to reduce the overall cycle time.

### DESCRIPTION OF THE INVENTION

The object of the present invention is to provide a control and/or identification method in an automatic machine for the production or the packaging of consumer products, in particular of the tobacco industry, which allows to keep the processing under control in an effective, efficient manner and with relatively low costs.

A further object of the present invention is to provide a control and/or identification method in an automatic machine for the production or the packaging of consumer products, in particular of the tobacco industry, which allows to identify and keep under control the components of the machine, and the operating members thereof, in an effective, efficient manner and with relatively low costs.

According to the present invention, a control and/or identification method is provided in an automatic machine for the production or the packaging of consumer products, in particular of the tobacco industry, according to what is claimed in the attached claims.

A further object of the present invention is to provide a control method to control a consumer product in an automatic machine for the production or the packaging of consumer products, in particular of the tobacco industry, which allows to control the consumer product in an effective, efficient manner and with relatively low costs.

According to the present invention, a control method to control a consumer product is also provided in an automatic machine for the production or the packaging of consumer products, in particular in the tobacco industry, according to what is claimed in the appended claims.

The appended claims also form an integral part of the present description.

### BRIEF DESCRIPTION OF THE DRAWINGS

The present invention will now be described with reference to the attached drawings, which illustrate some non-limiting examples of embodiments, wherein:

FIG. 1 is a schematic front view of a packaging machine which produces rigid packets of cigarettes and is controlled according to the control and/or identification method of the present invention;

FIG. 2 is a simplified block diagram of the control and/or identification method of the present invention;

FIG. 3 is a front and schematic view of a double machine for the production of filters which is controlled according to the control and/or identification method of the present invention;

FIG. 4 is a schematic view of a portion of a filter rod made by the machine of FIG. 4;

FIG. 5 is a perspective view of a packaging machine which produces single-dose cartridges for electronic cigarettes; and

FIG. 6 is a schematic view of a three-dimensional detection unit used by the control and/or identification method of the present invention.

### PREFERRED EMBODIMENTS OF THE INVENTION

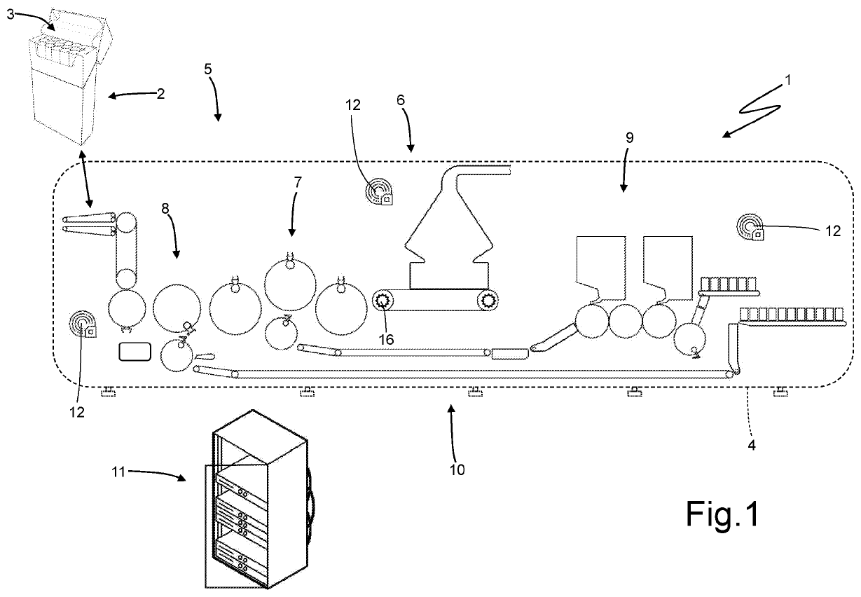

In FIG. 1 number 1 denotes as a whole an automatic packaging machine for producing a rigid packet of cigarettes 2, which comprises an outer container that is made of cardboard or rigid paperboard, is cup-shaped, houses an inner wrap containing a group 3 of cigarettes, and is provided with a hinged lid.

The automatic packaging machine 1 comprises a frame 4 which rests on the floor and supports a processing line 5 along which the processing (i.e. the packaging) of the cigarettes is performed. Along the processing line 5 there are arranged: a forming unit 6 in which the groups 3 of cigarettes are formed in succession, a wrapping unit 7 in which a wrapping sheet (typically metallized paper) is folded around each group 3 of cigarettes so as to form the corresponding inner wrap, and a wrapping unit 8 in which a blank (typically of cardboard and already provided with pre-weakened folding lines) is folded around each inner wrap to form the corresponding outer container provided with the hinged lid. A feeding unit 9 is coupled to the wrapping unit 7, which feeds the wrapping sheets in succession to form the inner wraps, while a feeding unit 10 is coupled to a wrapping unit 8, which feeds the blanks in succession to form the outer containers 2.

The automatic packaging machine 1 comprises a plurality of operating members (for example linear conveyors, rotating conveyors, gumming units, fixed folders, mobile folders, control members, support heads, pulleys, belts, pushers, pockets for groups 4 of cigarettes, electronic boards, electric motors, electric actuators, pneumatic valves . . . ), which are distributed along the processing line 5 in order to form the processing line (i.e. to form the various units 6-11 which make up the processing line 5). In other words, the processing line 5 is provided with a plurality of operating members and feeds and combines the materials (cigarettes, wrapping sheets, blanks of paper or cardboard, glue) used by the automatic packaging machine 1 to make the consumer products, or to make packs 2 of cigarettes.

Furthermore, the automatic packaging machine 1 comprises a control unit 11 which supervises the operation of the automatic packaging machine 1 and therefore of the processing line 5. The control unit 11 is connected to one or more hyperspectral detection units 12 (better described in the following), which are mounted near the automatic packaging machine 1 (not necessarily onto the frame 4 of the automatic packaging machine 1). Each hyperspectral detection unit 12 is designed to carry out a three-dimensional detection within its own operating volume (region of the space that can be examined by the hyperspectral detection unit 12) containing a corresponding part of the automatic packaging machine 1.

In the embodiment illustrated in FIG. 1, three hyperspectral detection units 12 are provided, each performs a detection inside its own operating volume which contains approximately one third of the automatic packaging machine 1; according to other embodiments not illustrated, the total number of hyperspectral detection units 12 varies from a minimum of one to a maximum of a few dozen depending on the size of the automatic packaging machine 1 and according to the control objectives.

It is important to emphasize that the hyperspectral detection units 12 can investigate the entire automatic packaging machine (i.e. the sum of the operating volumes of the individual hyperspectral detection units 12 contains the entire automatic packaging machine 1), or the hyperspectral detection units 12 can investigate only one or more parts of the automatic packaging machine 1 (i.e. the sum of the operating volumes of the hyperspectral detection units 12 does not contain the entire automatic packaging machine 1).

A hyperspectral detection unit 12 is a device comprising a plurality of detection unit elements capable of detecting the presence of radiation in a multiplicity of adjacent frequency bands (also partially overlapping) of the electromagnetic spectrum.

The radiation is detected in a portion of the environment defined as the operating volume, that is, in the volume reached by the sensitivity of the device since the radiation coming from inside this volume has sufficient energy to be detected by the device.

A high number of detection unit elements (even thousands or millions of detection unit elements) give the device the ability to detect very narrow adjacent bands of an electromagnetic spectrum in high definition, which can be extended between zero and a few hundred GHz (for example 300 GHz). This degree of definition can be reached by means of the use of innovative nanomaterials, such as those described in patents U.S. Pat. Nos. 8,963,265, 9,899,547 and 10,256,306.

The presence of alterations in natural magnetic fields, due to the presence of objects inside said operating volume, causes weak variations in the lines of the detected electromagnetic spectrum: therefore, in order to be able to effectively distinguish the variations of the spectrum lines, the device must be able to clearly distinguish very narrow frequency bands by means of a large number of detection unit elements. It is clear that, in the analysis of the spectrum lines highlighted by the detection unit 12, it is also necessary to consider the perturbations of natural magnetic fields due to the presence of artificial environmental electromagnetic sources.

The device can also perform a directional detection of radiation sources, that is, it can be able to provide information regarding the direction of origin of a given radiation by means of a different geometric arrangement of the detection unit elements, that is, the device allows a “stereoscopic” detection of the electromagnetic spectrum.

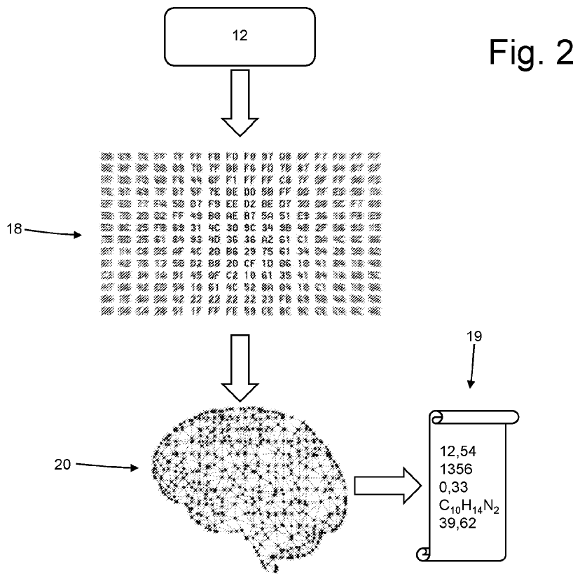

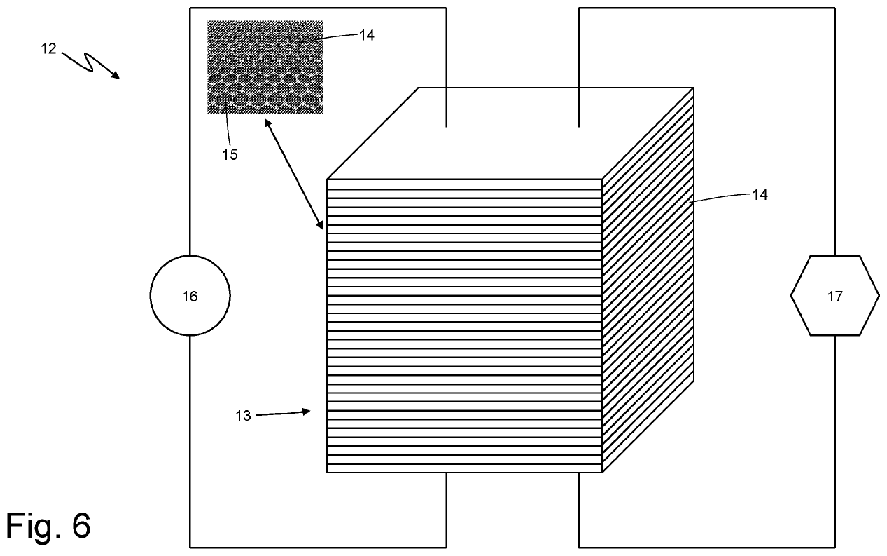

According to what is illustrated in FIG. 6, each detection unit 12 comprises a stack 13 formed by a plurality of sensitive layers 14 on top of one another; the sensitive layers 14 are made of nanomaterials (in particular graphene) and are deposited on respective inert substrates 15. According to a preferred embodiment illustrated in FIG. 2, each sensitive layer 14 is formed by a two-dimensional honeycomb made of carbon atoms. In other words, each sensitive layer 14 is a graphene nano tape, with a two-dimensional honeycomb made of carbon atoms, which allows a very high sensitivity. For example, each sensitive layer 14 can be made by means of a three-dimensional molecular printer which applies the nanomaterials on a substrate 15. Nanomaterials, such as carbon nanotubes, graphene, molybdenum disulfide and others, have interesting physical properties: they are highly sensitive and stable in extreme conditions, they are also light, hardened against radiation and require relatively little energy.

Each detection unit 12 comprises an electric generator 16 which is adapted to apply a time-varying electrical voltage to the ends of the stack 13 to energize the detection unit 12 and a measuring device 17 which detects variations in the electrical voltage at the ends of the stack 13 and/or in the electric current that passes through the stack 13. The variations in the electric voltage at the ends of the stack 13 and/or in the electric current that passes through the stack 13 made up raw data 18 (schematically illustrated in FIG. 2) that form, as output, (the measurement) of the detection unit 12 and which is processed as described in the following. In other words, each detection unit 12 is excited by applying electrical voltage to the ends of the stack 13 of the detection unit 12 and the raw data 18 is determined by detecting variations in the electrical voltage at the ends of the stack 13 of the detection unit and/or in the electric current passing through the stack 13 of the detection unit 12.

Sensitive elements can be made, for example, by means of a “molecular” three-dimensional printer which applies the nanomaterials on a substrate and arranges the detection unit elements (suitably treated to differentiate the same) by successive layers.

Each detection unit 12 performs a hyperspectral detection of the alterations of the magnetic or electromagnetic fields produced by all the objects present inside the operating volume, and is provided with a digital interface which provide, as output, a set of raw data 18 (schematically illustrated in FIG. 2) corresponding to the hyperspectral detections of the individual detection unit elements. The raw data 18 provided at the output of each detection unit 12 depend on the geometry and nature of all the objects present inside the operating volume of the detection unit 12.

In particular, each hyperspectral detection unit 12 arranged in the automatic packaging machine 1 provide, as output, a set of raw data 18 concerning the dimensions and/or position and/or shape and/or physical structure and/or chemical composition feature of all the objects present inside the operating volume of the detection unit 12.

As illustrated in FIG. 2, the raw data 18 provided by each hyperspectral detection unit 12 is filtered so as to isolate and extract information 19 concerning at least one single object present inside the operating volume of the detection unit 12, and the information 19 related to the single object are used by the control unit 11 to perform a control and/or identification operation.

A preliminary filtering operation may regard the elimination of all alterations of the electromagnetic field caused by the outer environment in which the automatic packaging machine 1 is located (for example walls, structures, accessory equipment, computers, etc. of the manufacturing site); i.e. the raw data 18 provided by each hyperspectral detection unit 12 is acquired in the absence of the automatic packaging machine 1 (i.e. caused only by the environment in which the automatic packaging machine 1 will be placed) to determine the electromagnetic field alterations caused by the outer environment and these alterations of the electromagnetic field caused by the outer environment are “subtracted” (eliminated, purified) from the raw data 18 provided by each hyperspectral detection unit 12 in the presence of the automatic packaging machine 1. This operation is therefore configured as an actual tare (calibration) performed with respect to the outer environment (to the automatic packaging machine 1).

To focus only on the information concerning the materials (cigarettes, wrapping sheets, blanks of paper or cardboard, glue) with which consumer products are made, it is possible to carry out a preliminary filtering operation to eliminate all the alterations of the electromagnetic field caused by the empty automatic packaging machine 1 (i.e. devoid of all materials) and stopped; i.e. the raw data 18 acquired by each hyperspectral detection unit 12 is acquired when the automatic packaging machine 1 is empty (i.e. devoid of all materials) and stopped to determine all the alterations of the electromagnetic field caused by the automatic packaging machine 1 empty (i.e. devoid of all the materials) and stopped and said alterations of the electromagnetic field caused by the empty automatic packaging machine 1 (i.e. devoid of all the materials) and stopped are “subtracted” (eliminated, purified) from the raw data 18 provided by each hyperspectral detection unit 12 in the presence of a full automatic packaging machine 1 (i.e. provided with materials) and in motion. This operation is therefore configured as a real tare (calibration) performed with respect to the empty automatic packaging machine 1 (i.e. devoid of all the materials) and obviously also with respect to the outer environment in which the automatic packaging machine 1 is located.

The isolation and extraction of information 19 concerning at least one single object present inside the operating volume of the detection unit 12 can follow or precede one or more classification operations (and possible subclassification) of the multitude of raw data 18.

According to a preferred embodiment, the raw data 18 provided massively by the hyperspectral detection unit 12 can be assimilated to a set of “big data” and is filtered by means of an artificial intelligence algorithm 20 so as to isolate and extract information 19 concerning at least one single object inside the operating volume. In particular, the artificial intelligence algorithm 20 comprises an artificial neural network that was trained to isolate and extract information 19 concerning at least one single object present inside the operating volume of the hyperspectral detection unit 12; i.e. the raw data 18 provided by each hyperspectral detection unit 12 is filtered by means of the artificial neural network which was trained to isolate and extract information 19 concerning at least one single object present inside the operating volume of the detection unit 12.

According to a possible embodiment, the raw data 18 provided by at least one hyperspectral detection unit 12 is processed so as to isolate and extract information 19 concerning at least one component of the automatic packaging machine 1, and the information 19 concerning the component of the automatic packaging machine 1 are used by the control unit 11 to identify the component.

In particular, the control unit 11 comprises a database of all possible components of the automatic packaging machine 1 and compares the information 19 obtained from the raw data 18 and concerning the component of the automatic packaging machine 1 to be identified with the information contained in all the possible components of the automatic packaging machine 1; in other words, the control unit 11 identifies the component by finding in the database, if present, the component that most corresponds to the information 19 obtained from the raw data 18 and concerning the component to be identified. In this embodiment, preferably but not necessarily, the overall operating volume of the hyperspectral detection units 12 (i.e. the set of operating volumes of the individual hyperspectral detection units 12) contains the entire automatic packaging machine 1, the raw data 18 provided by the hyperspectral detection units 12 is processed so as to isolate and extract information 19 concerning all components of the automatic packaging machine 1 which are in the global operating volume, and the control unit 11 uses the information 19 obtained from the raw data 18 and concerning each component of the automatic packaging machine 1 to identify the component; in this way, the control unit 11 using the identification of all the components of the automatic packaging machine 1 determines the configuration of the automatic packaging machine 1.

According to a possible embodiment, the raw data 18 provided by at least one hyperspectral detection unit 12 is processed so as to isolate and extract information 19 concerning at least one material, and therefore the control unit 11 uses the information 19 concerning the material and obtained from raw data 18 to establish whether the material complies with corresponding nominal specifications or not (therefore to check whether the materials fed to the automatic packaging machine 1 are of good quality).

According to a possible embodiment, the raw data 18 provided by at least one hyperspectral detection unit 12 is processed so as to isolate and extract information 19 concerning at least one material, and therefore the control unit 11 uses the information 19 concerning the material and obtained from the raw data 18 to identify the material (therefore also to check whether the materials fed to the automatic packaging machine 1 are correct).

According to a possible embodiment, the raw data 18 provided by at least one hyperspectral detection unit 12 is processed so as to isolate and extract information 19 concerning at least one semi-finished or finished product present in a predetermined position of the processing line 5, and therefore the control unit 11 uses the information 19 concerning the semi-finished or finished product and obtained from the raw data 18 to establish whether the semi-finished or finished product complies with corresponding nominal specifications or not (therefore whether need to be rejected or not). In other words, the control unit 11 uses the information 19 concerning at least one feature of a semi-finished or finished product to determine whether the semi-finished or finished product complies with the specifications and therefore is acceptable or if the semi-finished or finished product does not complies with the specifications and, hence, needs to be rejected.

From the above it is clear that the information 19 concerning the single object (a component of the automatic packaging machine 1, a material, a semi-finished or finished product) and obtained from the raw data 18 can be used by the control unit 11 to control at least an operating member of the automatic packaging machine 1.

The raw data 18 provided, as output, from each detection unit 12 are interpreted as a function of the Zeeman effect. The Zeeman effect is a phenomenon which consists in the separation of the spectral lines due to an outer magnetic field: it is observed that each line of the outer magnetic field splits into several very close lines, due to the interaction of the magnetic field with the angular and spin momenta of the electrons. In other words, the Zeeman effect is the division of a spectral line due to a magnetic field, that is, if a 300 nm atomic spectral line was considered under normal conditions, in a strong magnetic field, due to the Zeeman effect, the spectral line would be divided to produce a more energetic line and a less energetic line, in addition to the original line at 300 nm. The reason for the Zeeman effect is that in a magnetic field the quantum state of the angular momentum can undergo a shift from degeneration. For example, the orbital has three possible angular quantum states of the momentum that have degenerated (of the same energy) under normal circumstances. However, each quantum state of the angular momentum has a magnetic dipole momentum associated thereto, so the effect of a magnetic field is to separate the three states into three different energy levels. One state rises in energy, one lowers in energy and one remains at the same energy. The separation of these quantum states into three different energy levels causes three different states of excitation with slightly different energies that give rise to three slightly different spectral lines of energy (one with the same energy as the original spectral line, one more energetic and one less energetic) to the relaxation of the atom. This is the simplest case of the Zeeman effect, known as the normal Zeeman effect. The direct consequence of this effect is that some fields will be reflected by matter, others will be absorbed and others partially reflected and partially absorbed.

The geometric arrangement of the molecules will influence the way in which the fields will be reflected and all other chemical and physical parameters will influence the way in which the spectrum is partially or totally absorbed. Knowing how “something” acts in the presence of a magnetic field allows to determine all the parameters that characterize matter when the alteration (or disturbance) is observed. Examples of parameters are: temperature, chemical composition, chemical bonds, radiation, electric charge. Basically, anything that can be described by chemistry and physics is a parameter.

It is important to note that each hyperspectral detection unit 12 is completely passive, that is, it does not emit any form of energy (typically in the form of a mechanical or electromagnetic wave) which in some way affects (“illuminates”) the automatic packaging machine 1 or part of it or the materials/products present in the automatic packaging machine 1 (and obviously each detection unit 12 is not coupled to any emitting device which can emit a wave which in some way affects the automatic packaging machine 1 or the materials/products present in the automatic packaging machine 1). In other words, each hyperspectral detection unit 12 is not based on the principle of emitting mechanical or electromagnetic waves that effects (“illuminate”) the object to be investigated to detect the mechanical or electromagnetic waves reflected by the object. Each detection unit 12 in fact exploits a passive structure based on graphene and this technology based on graphene allows to detect small alterations of the natural EMF, MF and EM waves involved in the large spectrum of the analysis without emitting new radiation. In other words, each detection unit 12 detects changes in the electromagnetic energy already present in the detection volume without requiring the emission of any additional electromagnetic energy in the detection volume. Therefore, each detection unit 12 does not acquire “images” as a result of a “light” that lights up on the detection volume, but “listens” to the (ambient) background noise naturally present in the detection volume in a manner completely independent from the detection unit 12.

Each atom inserted in a magnetic or electromagnetic field produces an alteration. When the technology used by the hyperspectral detection units 12 is completely passive, it is important to understand which electromagnetic sources are involved in the detection. A first electromagnetic source involved in the detection is the magnetic field that extends from inside the Earth towards the space, where it encounters the solar wind, a flow of charged particles that emanate from the Sun. Its size on the Earth's surface varies from 25 to 65 microtesla (0.25 to 0.65 gauss). A second electromagnetic source involved in the detection are cosmic rays, that is, the high energy radiation that hits the Earth from space. Some of them have ultra-high energies in the 100-1000 TeV range. The peak of the energy distribution is around 0.3 GeV. A third electromagnetic source involved in the detection are artificial energy sources: most telecommunication systems base their operation on the electromagnetic field (Wi-Fi systems and 3G, 4G, 5G systems can diffuse radiation in a very large area). A fourth electromagnetic source involved in the detection is the environment: almost every form of matter emits a sort of electromagnetic field. In our environment things like the light bulb, the electronic circuit boards or the sun itself emit a large amount of energy in a wide spectral range.

Each detection unit 12 is able to detect the spectrum between 0 and 300 GHz due to the graphene-based detection unit which is a stack of multiple layers each made up of an array of multiple cells. Each cell is made up of monatomic graphene layers doped with specific materials that allow accurate and precise detection in a specific area of the spectrum. In this way it is possible to detect not only the perturbations of the electromagnetic field but also their spatial origin.

All the detected electromagnetic perturbations are then collected and stored in the raw data 18 which substantially contain all the alterations made by all the atoms in a specific volume. As mentioned above, the data is analyzed with an artificial neural network that allows to use classification and identification to detect a part of the analyzed spectrum useful for extracting the necessary output or for filtering the output in an intelligent manner.

By having a scan of every single atom and therefore of every single molecule it is possible to extract and analyze every object inserted in the detection volume. When a part of the spectrum crosses the matter, it is also possible to analyze invisible objects and extract: a three-dimensional model (it is possible to extract a three-dimensional model of everything inside the volume with an accuracy of up to half of a hydrogen atom), chemical data (it is possible to perform a complete chemical analysis of everything inside the volume also of organic matter extracting DNA and bacterial information as well), physical data (it is possible to extract physical data such as electrical parameters, electrical flow, temperatures, heat, brightness or having in real time a trace of particles of a fusion process), and quantum data (almost all the parameters that characterize an universe in terms of phenomena related to space-time such as the behavior of light).

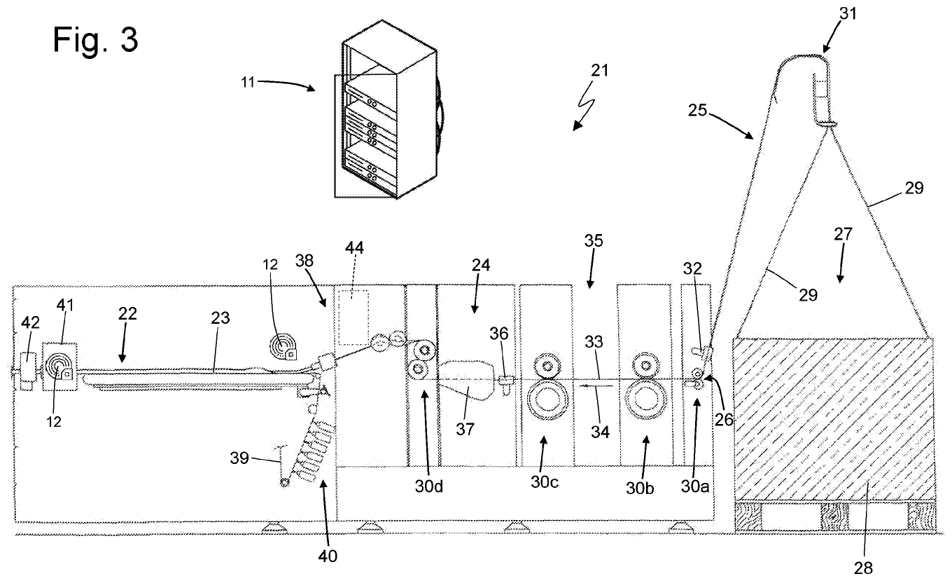

In FIG. 3, number 21 denotes as a whole an automatic double processing machine for the production of filters for cigarettes provided with a double processing line along which the processing (production) of the filters is carried out. The automatic processing machine 21 comprises a plurality of operating members (for example rotating drums, gumming devices, conveyors, control members, support heads, pulleys, belts, pushers, electronic boards, electric motors, electric actuators, pneumatic valves . . . ), which are distributed along the processing line to form the processing line. In other words, the processing line is formed by a plurality of operating members and feeds and combines the materials (filtering material, paper tapes, glue, etc.) which make up the consumer products used by the automatic processing machine 21, i.e. forming the filters.

The machine 21 comprises two beams 22 (only one of which is illustrated in FIG. 3) for the formation of two respective continuous filter rods 23 (only one of which is illustrated in FIG. 3) and, for each beam 22, a respective feeding line 24 to feed filtering material (only one of which is illustrated in FIG. 3). The feeding lines 24 are designed to receive, in turn, the filtering material from a conveying line 25, which is part of the machine 21 and extends between an input station 26 of the feeding lines 4 and a holding bin 27, in which two bales 28 of filtering material are contained (only one of which is illustrated in FIG. 3).

From the bales 28 respective rods 29 having a circular section are unwound, which are fed along the conveying line 25 due to the effect of the traction imparted to the rods 29 by a roller traction group 30 arranged in the input station 6.

The conveying line 25 comprises a guide device 31 for the rods 29 arranged above the bales 28 and an expanding device 32, which is arranged in the area of the input station 26 immediately upstream of the traction group 30 and is designed for widening transversally the rods 29 having a circular section by means of compressed air blows to form respective strips 33 having a flattened section (only one of which is illustrated in FIG. 3) which are then fed to the roller traction group 30a.

Downstream of the traction group 30a, the two strips 33 are fed, along the respective feeding lines 24 and in a substantially horizontal direction 34, through an ironing unit 35, which is formed by two roller traction groups 30b and 30c analogous to group 30a. Subsequently, the two strips 33 are fed, along the respective feeding lines 24 in the direction 34, through a dilator device 36, which is designed to blow air inside the strips 33 to increase the volume of the strips 33 themselves, and then through a treatment unit 37, in which the strips 33 are admixed with chemical substances (typically triacetin) suitable to impart aroma and plasticity to the filtering material. Finally, the two strips 33 are fed, along the respective feeding lines 24 in the direction 34, and through a roller traction group 30d, which is analogous to the groups 30 and 30b, 30c and defines an output portion of the feeding lines 24.

The feeding lines 24 are connected to the forming beams 22 by means of a conveying assembly 38. In each beam 22 the filtering material is fed over a previously gummed paper tape 39 in a gumming station 40 and subsequently wound transversely around the filtering material itself to conform and obtain a continuous cylindrical filter rod 23.

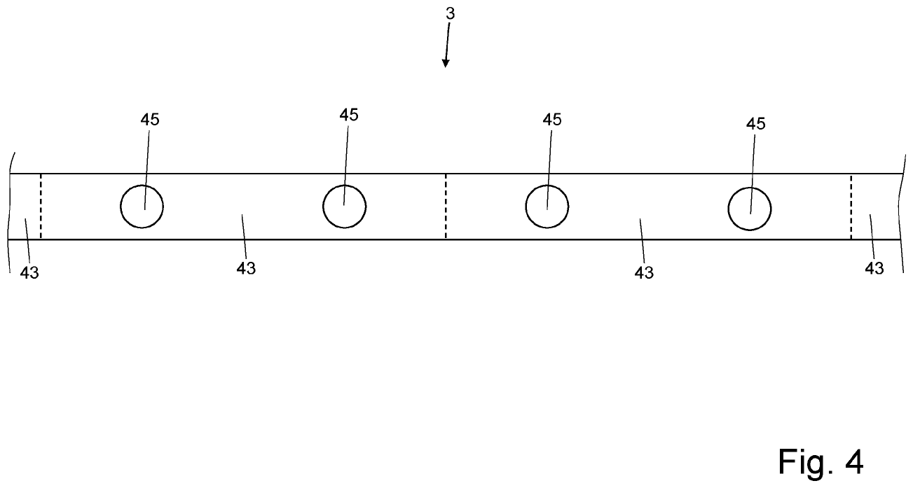

Finally, at the exit of the forming beams 2 and 2b a control station 41 to control the density of the filter rods 13 and a cutting head 42, which is adapted to cut transversely the rods 13 to obtain respective successions of filter portions 43 (illustrated in FIG. 4) are arranged.

In the area of the group 18 a feeding unit 44 is arranged to feed additive elements 45 (illustrated in FIG. 4) formed by spherical capsules which contain aromatizing substances (such as, for example, menthol) and which can be broken by crushing to release the aromatizing substances. The feeding unit 44 inserts the additive elements 45 into the filtering material with a step dependent on the feeding speed of the filtering material so that each filter portion 43 contains two uniformly distributed additive elements 45 (each filter portion 43 is subsequently used to form two different cigarettes and therefore is further divided into two identical halves).

According to a different embodiment not illustrated, the additive elements 45 can have a different shape (i.e. a shape different from the spherical shape). According to a further embodiment not illustrated, the additive elements 45 are formed by parallelepiped or cylindrical tablets of aromatizing substances.

In the embodiment illustrated in FIG. 3, the automatic machine 1 is a filter processing machine which produces filter portions 43 in each of which a breakable capsule 45 containing a liquid is inserted; according to a possible embodiment, the control unit 11 processes the raw data 18 provided by at least one hyperspectral detection unit 12 so as to isolate and extract information 19 concerning the breakable capsule 45 contained in each piece 43 of the filter. In particular, the raw data 18 provided by at least one hyperspectral detection unit 12 is processed so as to isolate and extract information 19 concerning the composition and/or the quantity of liquid contained in each breakable capsule 45.

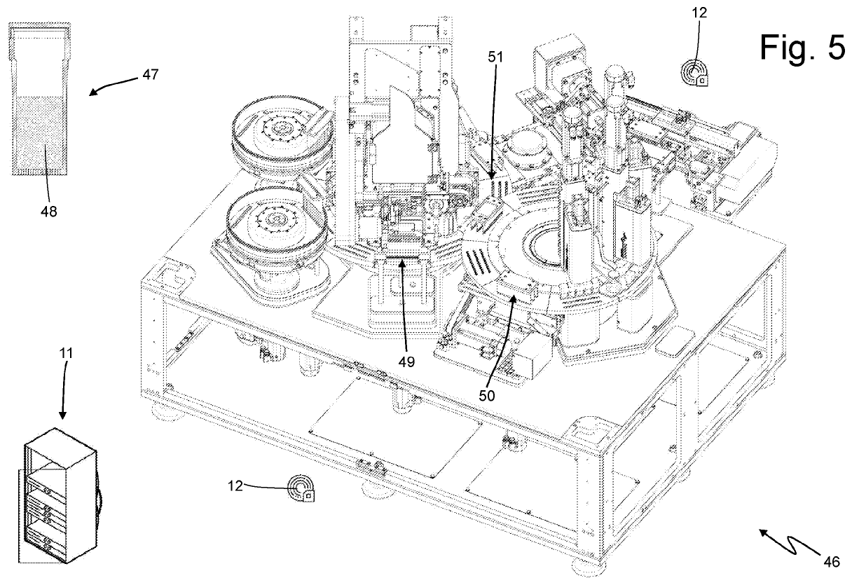

In FIG. 5 number 46 denotes as a whole an automatic processing machine for the production of disposable cartridges 47 for electronic cigarettes provided with a multiple processing line along which the processing (production) of the disposable cartridges 47 is performed. The automatic processing machine 46 comprises a plurality of operating members (for example rotating drums, gumming devices, conveyors, control members, support heads, pulleys, belts, pushers, electronic boards, electric motors, electric actuators, pneumatic valves . . . ), which are distributed along the production line to form the processing line. In other words, the processing line is formed by a plurality of operating members and feeds and combines the materials (casings, tobacco, filtering material, locking rings . . . ) which make up the consumer products used by the automatic processing machine 46, that make up the disposable cartridges 47.

Each disposable cartridge 47 comprises a tubular plastic casing having a micro-perforated bottom wall and a substantially cylindrical side wall; inside the tubular casing a dose of tobacco powder 48 is enclosed (in contact with the back wall) surmounted by a pad of filtering material.

The processing machine 46 has an intermittent movement, i.e. its conveyors cyclically alternate motion steps and stop steps. The processing machine 46 comprises a processing drum 49 which is arranged horizontally and is mounted rotatably around a vertical rotation axis. The processing drum 49 supports twelve groups of seats, each of which is designed to receive and contain a corresponding tubular casing. The processing machine 8 comprises a further processing drum 50 which is arranged horizontally alongside the processing drum 49 and is mounted rotatably around a vertical rotation axis; the processing drum 50 supports twelve groups of seats, each adapted to receive and contain a corresponding tubular casing. The tubular casings are transferred axially from the seats of a group of the processing drum 49 to the seats of a group of the processing drum 50 in a transfer station 51 in which the two processing drums 49 and 50 are partially overlapped.

In the embodiment illustrated in FIG. 5, the automatic machine 1 is a processing machine for the production of disposable cartridges 47 for electronic cigarettes each containing a dose 48 of an aromatic substance in the liquid state or in the solid state (for example, powdered tobacco); according to a possible embodiment, the control unit 11 processes the raw data 18 provided by at least one hyperspectral detection unit 12 so as to isolate and extract information 19 concerning the dose 48 of an aromatic substance contained in a disposable cartridge 47. In particular, the raw data 18 provided by at least one hyperspectral detection unit 12 is processed so as to isolate and extract information 19 concerning the composition and/or the quantity of aromatic substance contained in a disposable cartridge 47.

In particular, possible applications of the method described above concern the control of the position and integrity of aromatizing capsules arranged in cigarette filters (for example in the presence of two different capsules at a short distance from one another in a filter portion, so that the smoker can choose which to break in order to aromatize the aerosol, it is necessary to check: presence, position, geometry, type of content and quality of both capsules), the dimensional control of combined multisegmented filters and pieces of cigarette of the type “Heat Not Burn”, to check the weight measurement of tobacco derivatives (mixed in rolled tape or granules) or liquids in plastic or metal cartridges for electronic cigarettes, determining the position and geometric features of heating elements arranged in new smoking articles, to check the degree of humidity and the percentage of glycerine in treated tobacco used in new smoking articles, to check for the presence and position of spots or patterns of glue in the packaged product, to check the completeness of the carton of packs of cigarettes and of the boxes of cartons of cigarettes.

The automatic machines 1, 21 and 46 described above are related to the tobacco industry, but it is clear that the control and/or identification method described above can be implemented in automatic machines for the production or the packaging of consumer products of other fields such as the foodstuff field, the cosmetics field, the pharmaceutical field, or the healthcare field.

The embodiments described herein can be combined with each other without departing from the scope of the present invention.

The control and/or identification method described above has numerous advantages.

First of all, the control and/or identification method described above allows to keep under control the processing of the automatic machines 1, 21 and 46 in an effective and efficient manner.

Furthermore, the control and/or identification method described above can be easily implemented in an already existing automatic machine 1, 21 or 46, since the hyperspectral detection units 12 have a small size and a sufficiently large operating volume (up to a few cubic meters); consequently, the assembly of the hyperspectral detection units 12 in an already existing automatic machine 1, 21 or 46, is always very easy.

Finally, the control and/or identification method described above is inexpensive to implement because despite the refined technology of the hyperspectral detection units 12, their production cost is not particularly high thanks to the use of three-dimensional molecular printers.

Scanning the lowest possible level is a challenge: tackling this challenge allows hyperspectral detection units 12 to take from one single detection a multitude of parameters in different physical domains: chemical parameters of the entire volume being object of detection, three-dimensional geometric parameters (outer and inner features) of each object inside the volume subject to detection, physical parameters such as temperature, heat and so on, dynamic and kinetic parameters such as flow rate and linear movements.

The hyperspectral detection units 12 are not affected by dust, light or other types of EM and EMF disturbance and there are no special conditions that must be guaranteed for good results.

For the hyperspectral detection units 12 there are no limits of shape or materials in terms of detection capability; every object in every material inside the volume object of the detection can be investigated without any kind of preprocessing.

For the hyperspectral detection units 12 it is possible to obtain good detection results regardless of the quantity of objects being analyzed and whether the objects being analyzed are moving.

1. A control and/or identification method in an automatic machine (1, 21, 46) for the production or the packaging of consumer products; wherein the automatic machine (1, 21, 46) comprises at least one processing line (5), which is provided with a plurality of operating members and feeds at least one material, which is used to manufacture the consumer products; the control and/or identification method comprises the steps of:
carrying out, inside a volume containing at least part of the automatic machine (1, 21, 46), a three-dimensional detection by means of at least one hyperspectral detection unit (12) for detecting the alterations of the electromagnetic field produced by all the objects present inside the volume, which hyperspectral detection unit (12) produces, as an output, raw data (18) concerning the dimensions and/or the position and/or the shape and/or the physical structure and/or the chemical composition of all the objects present inside the volume;
filtering the raw data (18) provided by the hyperspectral detection unit (12) so as to isolate and extract information (19) concerning at least one single object present inside the volume; and
using the information (19) concerning the single object to carry out a control and/or identification operation;
wherein the hyperspectral detection unit (12) comprises a plurality of detection unit elements capable of detecting the presence of radiation in a multiplicity of adjacent frequency bands of the electromagnetic spectrum; and
wherein the hyperspectral detection unit (12) is completely passive and does not emit any form of energy which at least partially effects the automatic machine (1, 21, 46), the material or the consumer products.

2. The control and/or identification method according to claim 1 and comprising the further steps of:
determining the raw data (18) provided by the detection unit (12) under initial calibration conditions; and
cleaning the raw data (18) provided in use by the detection unit (12) by using the raw data (18) provided by the detection unit (12) under initial calibration conditions.

3. The control and/or identification method according to claim 1, wherein the raw data (18) provided by the hyperspectral detection unit (12) is filtered by means of an artificial intelligence algorithm (20) so as to isolate and extract information (19) concerning at least one single object present inside said volume.

4. The control and/or identification method according to claim 1, wherein the raw data (18) provided by the hyperspectral detection unit (12) is filtered by means of an artificial neural network, which was trained to isolate and extract information (19) concerning at least one single object present inside said volume.

5. The control and/or identification method according to claim 1, wherein:
the raw data (18) is processed so as to isolate and extract information (19) concerning at least one component of the automatic machine (1, 21, 46); and
the information (19) concerning the component of the automatic machine (1, 21, 46) is used to identify the component.

6. The control and/or identification method according to claim 5, wherein:
the information (19) concerning the component of the automatic machine (1, 21, 46) is compared with the information contained in a database of all possible components of the automatic machine (1, 21, 46); and
the component is identified by finding in the database, if present, the component that most corresponds to the information (19) obtained from the raw data (18).

7. The control and/or identification method according to claim 1, wherein:
said volume contains the entire automatic machine (1, 21, 46);
the raw data (18) is processed so as to isolate and extract information (19) concerning all the components of the automatic machine (1, 21, 46);
the information (19) concerning each component of the automatic machine (1, 21, 46) is used to identify the component; and
the configuration of the automatic machine (1, 21, 46) is determined by using the identification of all the components of the automatic machine (1, 21, 46).

8. The control and/or identification method according to claim 1, wherein:
the raw data (18) is processed so as to isolate and extract information (19) concerning at least one material; and
the information (19) concerning the material is used to establish whether the material complies with corresponding nominal specifications or not.

9. The control and/or identification method according to claim 1, wherein:
the raw data (18) is processed so as to isolate and extract information (19) concerning at least one material; and
the information (19) concerning the material is used to identify the material.

10. The control and/or identification method according to claim 1, wherein:
the raw data (18) is processed so as to isolate and extract information (19) concerning at least one semi-finished or finished product present in a predetermined position of the processing line (5); and
the information (19) concerning the semi-finished or finished product is used to establish whether the semi-finished or finished product complies with corresponding nominal specifications or not.

11. The control and/or identification method according to claim 10, wherein:
the automatic machine (1, 21, 46) is a filter processing machine, which produces filter portions (43) each containing at least one breakable capsule (45) containing liquid; and
the raw data (18) is processed so as to isolate and extract information (19) concerning the breakable capsule (45) contained in a filter portion (43).

12. The control and/or identification method according to claim 11, wherein the raw data (18) is processed so as to isolate and extract information (19) concerning the composition and/or the quantity of liquid contained in a breakable capsule (45).

13. The control and/or identification method according to claim 10, wherein:
the automatic machine (1, 21, 46) is a processing machine for the production of disposable cartridges (45) for electronic cigarettes, each containing a dose (46) of an aromatic substance in the liquid state or in the solid state; and
the raw data (18) is processed so as to isolate and extract information (19) concerning the dose (46) of aromatic substance contained in a disposable cartridge (45).

14. The control and/or identification method according to claim 13, wherein raw data (18) is processed so as to isolate and extract information (19) concerning the composition and/or the quantity of aromatic substance contained in a disposable cartridge (45).

15. The control and/or identification method according to claim 1, wherein the information (19) concerning the single object is used to control at least one operating member of the automatic machine (1, 21, 46).

16. The control and/or identification method according to claim 1, wherein the three-dimensional detection unit (12) comprises a plurality of sensitive layers (14) formed by nanomaterials and deposited on respective substrates (15).

17. The control and/or identification method according to claim 16, wherein each sensitive layer (14) is formed by a two-dimensional honeycomb made of carbon atoms.

18. The control and/or identification method according to claim 16, wherein the three-dimensional detection unit (12) is excited by applying electrical voltage to the ends of the three-dimensional detection unit (12) and the raw data (18) is determined by detecting variations in the electrical voltage at the ends of the three-dimensional detection unit (12) and/or in the electric current passing through the three-dimensional detection unit (12).

19. The control and/or identification method according to claim 16, wherein the raw data (18) provided at the output of the three-dimensional detection unit (12) is interpreted according to the Zeeman effect.

20. An automatic machine (1, 21, 46) for the production or the packaging of consumer products, comprising at least one processing line (5), which is provided with a plurality of operating members and feeds at least one material, which is used to manufacture the consumer products; the automatic machine (1, 21, 46) comprises:
at least one hyperspectral detection unit (12), which is designed to carry out, inside a volume containing at least part of the automatic machine (1, 21, 46), a three-dimensional detection, which hyperspectral detection unit (12) produces, as an output, raw data (18) concerning the dimensions and/or the position and/or the shape and/or the physical structure and/or the chemical composition of all the objects present inside the volume; and
a processing system, which is designed to filter the raw data (18) provided by the hyperspectral detection unit (12) so as to isolate and extract information (19) concerning at least one single object present inside the volume, and to use the information (19) concerning the single object to carry out a control and/or identification operation;
wherein the hyperspectral detection unit (12) comprises a plurality of detection unit elements capable of detecting the presence of radiation in a multiplicity of adjacent frequency bands of the electromagnetic spectrum; and
wherein the hyperspectral detection unit (12) is completely passive and does not emit any form of energy which at least partially effects the automatic machine (1, 21, 46), the material or the consumer products.

21. A control method to control a consumer product in an automatic machine (1, 21, 46) for the production or the packaging of consumer products; wherein the automatic machine (1, 21, 46) comprises at least one processing line (5), which is provided with a plurality of operating members and feeds at least one material, which is used to manufacture the consumer products;
the control method comprises the steps of:
carrying out, inside a volume containing at least one consumer product, a three-dimensional detection by means of at least one hyperspectral detection unit (12) for detecting the alterations of the electromagnetic field produced by all the objects present inside the volume, which hyperspectral detection unit (12) produces, as an output, raw data (18) concerning the dimensions and/or the position and/or the shape and/or the physical structure and/or the chemical composition of all the objects present inside the volume;
filtering the raw data (18) provided by the hyperspectral detection unit (12) so as to isolate and extract information (19) concerning at least one dimension and/or position and/or shape and/or physical structure and/or chemical composition feature of the consumer product present inside the volume; and
using the information (19) concerning said at least one feature of the consumer product in order to establish whether the consumer product complies with the specifications and, hence, is acceptable or whether the consumer product does not comply with the specification and, hence, needs to be rejected;
wherein the hyperspectral detection unit (12) comprises a plurality of detection unit elements capable of detecting the presence of radiation in a multiplicity of adjacent frequency bands of the electromagnetic spectrum; and
wherein the hyperspectral detection unit (12) is completely passive and does not emit any form of energy which at least partially effects the automatic machine (1, 21, 46), the material or the consumer products.

22. The control and/or identification method according to claim 21 and comprising the further steps of:
determining the raw data (18) provided by the detection unit (12) under initial calibration conditions; and
cleaning the raw data (18) provided in use by the detection unit (12) by using the raw data (18) provided by the detection unit (12) under initial calibration conditions.

23. (canceled)

24. (canceled)

25. (canceled)

26. The control method according to claim 21, wherein:
the automatic machine (1, 21, 46) is a filter processing machine, which produces filter portions (43) each containing at least one breakable capsule (45) containing liquid; and
the raw data (18) is processed so as to isolate and extract information (19) concerning the breakable capsule (45) contained in a filter portion (43).

27. The control method according to claim 26, wherein raw data (18) is processed so as to isolate and extract information (19) concerning the composition and/or the quantity of liquid contained in a breakable capsule (45).

28. The control method according to claim 21, wherein:
the automatic machine (1, 21, 46) is a processing machine for the production of disposable cartridges (45) for electronic cigarettes each containing a dose (46) of an aromatic substance in the liquid state or in the solid state; and
the raw data (18) is processed so as to isolate and extract information (19) concerning the dose (46) of aromatic substance contained in a disposable cartridge (45).

29. The control method according to claim 28, wherein raw data (18) is processed so as to isolate and extract information (19) concerning the composition and/or the quantity of aromatic substance contained in a disposable cartridge (45).

30. The control method according to claim 21, wherein the processing line (5) feeds and combines at least two materials, which make up the consumer products.

31. (canceled)
